(19) United States
(12) Patent Application Publication
(10) Pub. No.: US 2007/0113082 A1
(43) Pub. Date: May 17, 2007

(54) Login method for a wireless network with security settings, and wireless network system with security settings

(75) Inventors: Alexander I-Chi Lai, Taipei Hsien (TW); Pei-Ling Yu, Taipei Hsien (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ACER INC., Taipei Hsien (TW)

(21) Appl. No.: 11/449,984

(22) Filed: Jun. 8, 2006

(30) Foreign Application Priority Data
Nov. 3, 2005 (TW) 094138609

(51) Int. Cl. H04L 9/00

(52) U.S. Cl. 713/168; 340/7.1; 709/220; 370/254; 455/435.1; 340/5.64

(57) ABSTRACT

In a login method for a wireless network with security settings, security settings data for a wireless local area network is provided in a portable wireless device (such as a remote controller) capable of two-way wireless transmission. When it is intended to log a new wireless network device in to the wireless local area network, the portable wireless device is operated to provide the security settings data to the new wireless network device. Therefore, the new wireless network device is able to log in to the wireless local area network upon completing security setup using the security settings data received from the portable wireless device. A wireless network system with security settings is also disclosed.

### CROSS-REFERENCE TO RELATED APPLICATION

This application claims priority of Taiwanese application no. 094138609, filed on Nov. 3, 2005.

### BACKGROUND OF THE INVENTION

1. Field of the Invention

This invention relates to wireless networks, more particularly to a login method for a wireless network with security settings. This invention also relates to a wireless network system with security settings.

2. Description of the Related Art

Since wireless communications schemes (such as Wi-Fi, 802.11a/b/g, etc.) commonly employed by wireless networks do not use physical transmission lines for communications, it is not possible to prevent the transmission content from being intercepted by a third party. Therefore, in order to meet the requirements of information security and confidentiality, wireless networks usually require security keys for protecting transmission content when connecting thereto. Examples of the security keys include wired-equivalent privacy (WEP) keys and Wi-Fi protected access (WPA) keys used in 802.11a/b/g. These keys are typically a long string of digits with a specific mathematical meaning (such as a prime number), and are applied for communication encryption and decryption. In other words, wireless networks with a security key protection mechanism are configured to reject access, i.e., unable to log in or correctly decode encrypted transmission content, to those users who do not have the correct key value. However, such a protection mechanism often arises in user inconvenience.

In the prior art, when the user of a wireless network device (such as a personal computer, not shown) wishes to log in to a wireless local area network, the user must manually input security settings values for the wireless local area network. Login to the wireless local area network environment is possible only when the correct service set identifier (SSID) and the correct WEP key are inputted by the user through the wireless network device. This conventional scheme, which requires users to remember a long string of digits, not only makes it difficult for users to comprehend the meaning and complexity of such protection, but also makes it hard for users to setup or remember correct keys. Therefore, many users either completely disable key settings or setup very simple keys, which arises in inadequate security protection. Moreover, different settings are required when logging in to different wireless networks, thereby resulting in added user burden.

In the prior art, users may connect a portable storage device (such as a flash memory device) to a universal serial bus (USB) port of a network device that has already been logged in to a wireless network for storing the service set identifier (SSID) and the security key data of the wireless network in the portable storage device. The portable storage device may then be connected to an electronic device that has yet to be logged in to the wireless network so as to provide the SSID and the security key data thereto for decryption. However, this conventional method is not suitable for network devices, such as wireless access points, that are not provided with USB ports or the like. Moreover, this conventional method requires frequent plugging and unplugging of the portable storage device, and increases the likelihood of misplacing the portable storage device.

Broadcom Corporation has recently introduced SecureEasySetup™ technology that involves pushing of buttons on a router and a client to transmit the service set identifier (SSID) and the security key wirelessly from the router to the client, thereby simplifying network configuration and security setup. However, the Broadcom technology requires the two devices to be located close to each other during network configuration and security setup, which is both impractical and inconvenient. Moreover, the technology is available only on products equipped with a proprietary chipset, which limits its applications.

### SUMMARY OF THE INVENTION

Therefore, the main object of the present invention is to provide a login method for a wireless network with security settings, which dispenses with the need for users to remember long strings of digits, which does not require frequent plugging and unplugging of hardware devices, which can be applied to a wide range of products, and which is fast and convenient.

Another object of the present invention is to provide a wireless network system with security settings to implement the login method of this invention.

According to one aspect of the present invention, there is provided a login method for a wireless network with security settings. The login method is adapted to be implemented by a wireless network system including a first wireless network device that has already been logged in to a wireless local area network, a second wireless network device that has yet to be logged in to the wireless local area network, and a portable wireless device that is capable of two-way wireless transmission with each of the first and second wireless network devices. The login method comprises the steps of:

a) enabling the first wireless network device to output security settings data for the wireless local area network in response to a control signal received from the portable wireless device;

b) enabling the portable wireless device to store the security settings data received from the first wireless network device, and to provide the security settings data to the second wireless network device in response to user manipulation of the portable wireless device; and

c) enabling the second wireless network device to perform security setup with reference to the security settings data received from the portable wireless device, and to log in to the wireless local area network thereafter.

According to another aspect of the present invention, there is provided a login method for a wireless network with security settings. The login method is adapted to be implemented by a wireless network system including a wireless local area network, a wireless network device that has yet to be logged in to the wireless local area network, and a portable wireless device that is capable of two-way wireless transmission with the wireless network device. The login method comprises the steps of:

a) providing security settings data for the wireless local area network in the portable wireless device, and enabling the portable wireless device to provide the security settings data to the wireless network device in response to user manipulation of the portable wireless device; and

b) enabling the wireless network device to decrypt the security settings data received from the portable wireless device, and to log in to the wireless local area network thereafter.

According to yet another aspect of the present invention, there is provided a wireless network system that has security settings, and that comprises a wireless local area network and a portable wireless device. The wireless local area network includes a wireless access point adapted to be connected to a network interface, and a first wireless network device connected to the wireless access point and capable of generating security settings data for the wireless local area network. The portable wireless device is capable of two-way transmission of wireless signals with the first wireless network device. The wireless network system further comprises a second wireless network device that is capable of two-way transmission of wireless signals with the first wireless network device and the portable wireless device. The portable wireless device is operable so as to issue a control signal to the first wireless network device such that the first wireless network device transmits the security settings data to the portable wireless device in response to the control signal from the portable wireless device. The portable wireless device is further operable so as to store the security settings data received from the first wireless network device, and so as to transmit the security settings data to the second wireless network device in response to user manipulation of the portable wireless device. The second wireless network device is operable so as to decrypt the security settings data received from the portable wireless device, and so as to log in to the wireless local area network thereafter.

### BRIEF DESCRIPTION OF THE DRAWINGS

Other features and advantages of the present invention will become apparent in the following detailed description of the preferred embodiment with reference to the accompanying drawings, of which:

FIG. 1 illustrates the preferred embodiment of a wireless network system with security settings according to the present invention;

FIG. 2 is a schematic circuit block diagram of the system of FIG. 1; and

FIG. 3 is a flowchart to illustrate steps of the preferred embodiment of a login method for a wireless network with security settings according to the present invention.

### DETAILED DESCRIPTION OF THE PREFERRED EMBODIMENT

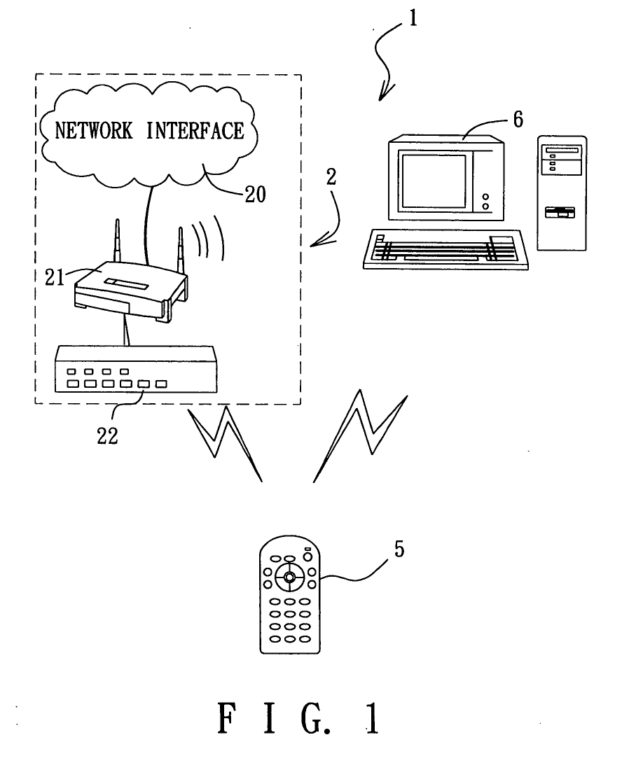

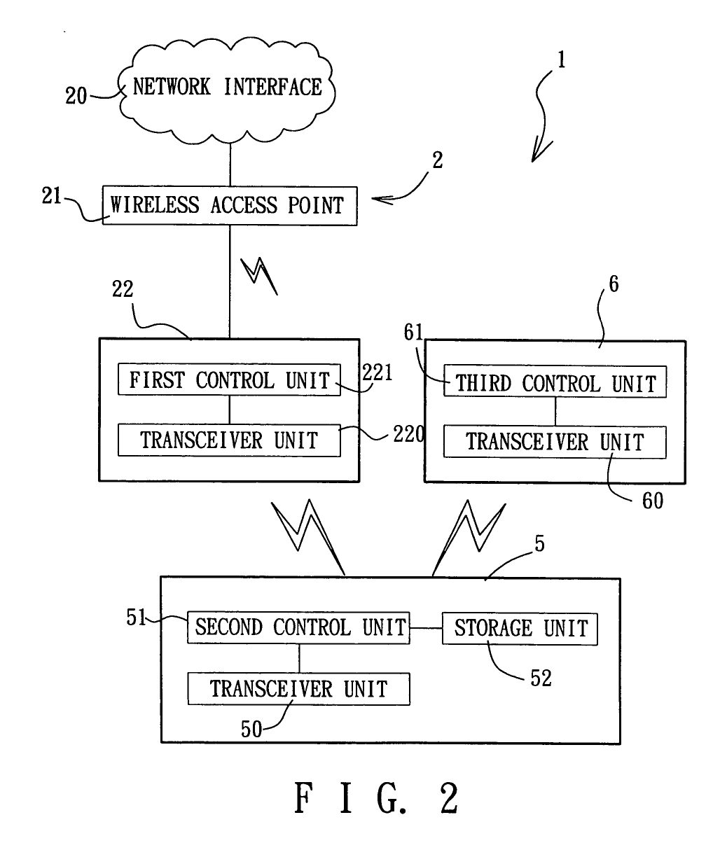

Referring to FIGS. 1 and 2, the preferred embodiment of a wireless network system 1 according to the present invention is shown to comprise a first wireless network device 22 that has already been logged in to a wireless local area network 2, a portable wireless device 5, and a second wireless network device 6 that has yet to be logged in to the wireless local area network 2.

The wireless local area network 2 further includes a network interface 20 and a wireless access point 21 (such as a wireless router) connected to the network interface 20. The first wireless network device 22 can be any one of but is not limited to the following devices having two-way wireless transmission functionality: a computer, a personal digital assistant, a digital media adaptor, and a media gateway. In this embodiment, the first wireless network device 22 is exemplified as a media gateway that has a wired or wireless network connection with the wireless access point 21 and that has already been logged in to the wireless local area network 2. The first wireless network device 22 includes a transceiver unit 220 and a first control unit 221 (see FIG. 2). The transceiver unit 220 is capable of two-way (i.e., receive and transmit) data transmission. The first control unit 221 can be controlled so as to generate and control access to security settings data for the wireless local area network 2. The security settings data includes at least one of a service set identifier (SSID) and security key data. The security key data includes one of wired-equivalent privacy (WEP) key data and Wi-Fi protected access (WPA) key data.

The portable wireless device 5 (such as a remote controller or a personal digital assistant capable of two-way wireless transmission) includes a transceiver unit 50, a second control unit 51, and a storage unit 52. The transceiver unit 50 is capable of two-way transmission of wireless signals with the first wireless network device 22. The second control unit 51 is responsive to user operation so as to issue control signals for access control of the security settings data in a manner to be described hereinafter. The storage unit 52, such as a flash memory, is used for storing data.

The second wireless network device 6 can be any one of but is not limited to the following devices having two-way wireless transmission functionality: a computer, a personal digital assistant, a digital media adaptor, and a media gateway. In this embodiment, the second wireless network device 6 is exemplified as a computer that has yet to be logged in to the wireless local area network 2. The second wireless network device 6 includes a transceiver unit 60 capable of two-way transmission of wireless signals with the first wireless network device 22 and the portable wireless device 5, and a third control unit 61. The third control unit 61 is responsible for decrypting the security settings data received by the second wireless network device 6, and uses the decrypted information to log in to the wireless local area network 2.

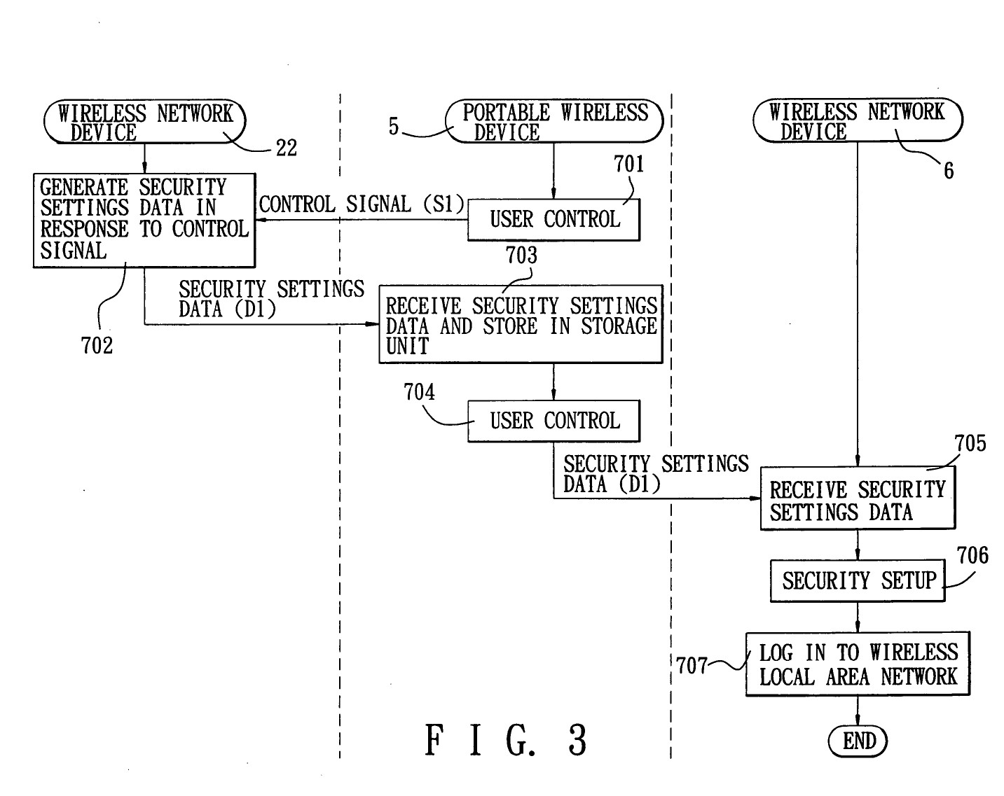

The preferred embodiment of the login method for a wireless network with security settings according to this invention will now be described with further reference to FIG. 3. First, in step 701, the portable wireless device 5 is operated (for example, a Setup button thereof is pressed) so that the second control unit 51 is able to issue a control signal (S1) to the first wireless network device 22 via the transceiver unit 50. In step 702, when the first control unit 221 of the first wireless network device 22 receives the control signal (S1) from the portable wireless device 5 via the transceiver unit 220, the first control unit 221 responds to the control signal (S1) by generating the security settings data (D1) including the service set identifier (SSID) and the security key data used during security setup with the wireless access point 21, and by providing the security settings data (D1) thus generated to the portable wireless device 5 via the transceiver unit 220. Then, in step 703, when the second control unit 51 of the portable wireless device 5 receives the security settings data (D1) from the first wireless network device 22 via the transceiver unit 50, the second control unit 51 stores the security settings data (D1) in the storage unit 52. In practice, since other methods may be employed to provide and store the security settings data in the portable wireless device 5, the present invention should not be limited in this particular aspect.

When it is desired to connect the second wireless network device 6 to the wireless local area network 2, the service set identifier (SSID) and the security key data must be first provided to the second wireless network device 6. Hence, in step 704, the portable wireless device 5 is operated (for example, another Setup button thereof is pressed) so as to enable the second control unit 51 to provide the security settings data (D1) stored in the storage unit 52 to the second wireless network device 6 via the transceiver unit 50. Then, in step 705, when the third control unit 61 of the second wireless network device 6 receives the security settings data (D1), the third control unit 61 decrypts the security settings data (D1) and performs security setup based on the decrypted security settings in step 706, and logs in to the wireless local area network 2 thereafter in step 707.

It has thus been shown that, through the method and system of this invention, users are able to easily setup new network devices to be included in a wireless local area network. In particular, users only need to store security settings data in a portable wireless device 5 (such as a remote controller), and to control the portable wireless device 5 so as to provide the security settings data to a new network device for decryption. As a result, users are not required to remember security key data in the form of long strings of digits. Moreover, since the security settings data is transmitted wirelessly, there is no need for frequent plugging and unplugging of hardware devices, and there is no requirement for devices (such as wireless access points) to be provided with USB ports or the like. Furthermore, since the portable wireless device 5 has inherent characteristics of portability and long-range transmission and reception, the first and second wireless network devices 22, 6 need not be placed close to each other during security setup, thereby resulting in added convenience.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A login method for a wireless network with security settings, said login method being adapted to be implemented by a wireless network system including a first wireless network device that has already been logged in to a wireless local area network, a second wireless network device that has yet to be logged in to the wireless local area network, and a portable wireless device that is capable of two-way wireless transmission with each of the first and second wireless network devices, said login method comprising the steps of:
a) enabling the first wireless network device to output security settings data for the wireless local area network in response to a control signal received from the portable wireless device;
b) enabling the portable wireless device to store the security settings data received from the first wireless network device, and to provide the security settings data to the second wireless network device in response to user manipulation of the portable wireless device; and
c) enabling the second wireless network device to perform security setup with reference to the security settings data received from the portable wireless device, and to log in to the wireless local area network thereafter.

2. The login method as claimed in claim 1, wherein the security settings data includes at least one of a service set identifier (SSID) and security key data.

3. The login method as claimed in claim 2, wherein the security key data includes one of wired-equivalent privacy (WEP) key data and Wi-Fi protected access (WPA) key data.

4. A login method for a wireless network with security settings, said login method being adapted to be implemented by a wireless network system including a wireless local area network, a wireless network device that has yet to be logged in to the wireless local area network, and a portable wireless device that is capable of two-way wireless transmission with the wireless network device, said login method comprising the steps of:
a) providing security settings data for the wireless local area network in the portable wireless device, and enabling the portable wireless device to provide the security settings data to the wireless network device in response to user manipulation of the portable wireless device; and
b) enabling the wireless network device to decrypt the security settings data received from the portable wireless device, and to log in to the wireless local area network thereafter.

5. The login method as claimed in claim 4, wherein, in step a), the security settings data is provided to the portable wireless device by another wireless network device, which has already been logged into the wireless local area network and which provides the security settings data to the portable wireless device in response to a control signal received from the portable wireless device.

6. A wireless network system with security settings, comprising:
a wireless local area network including a wireless access point adapted to be connected to a network interface, and a first wireless network device connected to said wireless access point and capable of generating security settings data for said wireless local area network;
a portable wireless device capable of two-way transmission of wireless signals with said first wireless network device; and
a second wireless network device capable of two-way transmission of wireless signals with said first wireless network device and said portable wireless device;
wherein said portable wireless device is operable so as to issue a control signal to said first wireless network device such that said first wireless network device transmits the security settings data to said portable wireless device in response to the control signal from said portable wireless device;
wherein said portable wireless device is further operable so as to store the security settings data received from said first wireless network device, and so as to transmit the security settings data to said second wireless network device in response to user manipulation of said portable wireless device; and
wherein said second wireless network device is operable so as to decrypt the security settings data received from said portable wireless device, and so as to log in to said wireless local area network thereafter.

7. The wireless network system with security settings as claimed in claim 6, wherein said wireless access point includes a router.

8. The wireless network system with security settings as claimed in claim 6, wherein said first wireless network device includes one of a computer, a personal digital assistant, a digital media adaptor, and a media gateway.

9. The wireless network system with security settings as claimed in claim 6, wherein said second wireless network device includes one of a computer, a personal digital assistant, a digital media adaptor, and a media gateway.

10. The wireless network system with security settings as claimed in claim 6, wherein said portable wireless device includes one of a remote controller and a personal digital assistant.

11. The wireless network system with security settings as claimed in claim 6, wherein said first wireless network device has a wired network connection with said wireless access point.

12. The wireless network system with security settings as claimed in claim 6, wherein said first wireless network device has a wireless network connection with said wireless access point.

13. The wireless network system with security settings as claimed in claim 6, wherein said portable wireless device includes a transceiver unit capable of two-way transmission of the wireless signals.

14. The wireless network system with security settings as claimed in claim 6, wherein each of said first and second wireless network devices includes a transceiver unit capable of two-way transmission of the wireless signals.

15. The wireless network system with security settings as claimed in claim 6, wherein the security settings data includes at least one of a service set identifier (SSID) and security key data.

16. The wireless network system with security settings as claimed in claim 15, wherein the security key data includes one of wired-equivalent privacy (WEP) key data and Wi-Fi protected access (WPA) key data.
